(19) United States
(12) Patent Application Publication
(10) Pub. No.: US 2008/0069942 A1
(43) Pub. Date: Mar. 20, 2008

(54) Flax-stabilized fatty acid compositions and methods

(76) Inventor: Glenn Roy Pizzey, Angusville (CA)

Correspondence Address: WINSTON & STRAWN LLP;PATENT DEPARTMENT, 1700 K STREET, N.W., WASHINGTON, DC, 20006, US

(21) Appl. No.: 11/521,503

(22) Filed: Sep. 15, 2006

(51) Int. Cl. A23D 9/00

(52) U.S. Cl. 426/601

(57) ABSTRACT

Flax-stabilized fatty acid compositions, methods for preparation thereof, and products containing the same are included. The stabilized fatty acid composition includes a fatty acid and a stable, milled or powdered flax component that is associated with the fatty acid component and that is present in an amount sufficient to increase the stability and shelf-life of the fatty acid component. The fatty acid component and flax component are substantially uniformly dispersed throughout the composition. A preferred method of preparing such stable fatty acid compositions includes mixing a stable, milled or powdered flax component and a fatty acid component to form a stable flax/fatty acid mixture.

### FIELD OF THE INVENTION

The present invention is directed to flax-stabilized fatty acid compositions, methods for preparing such compositions, and products including the same. In particular, the flax and fatty acid components of the compositions are present in an amount sufficient to increase the stability and shelf-life of the fatty acid component while not significantly increasing the stability of the flax component.

### BACKGROUND OF THE INVENTION

Fatty acids have been known to be an important food additive or dietary supplement in providing a variety of health benefits. As disclosed in U.S. Pat. No. 6,428,461 to Marquez et al., omega-3 long chain polyunsaturated fatty acids, in particular, have been viewed as highly attractive. Certain fish oils, such as capelin oil, cod liver oil, and menhaden oil, contain large amounts of highly unsaturated long chain fatty acids, such as eicosapentaenoic acid (EPA), docosahexaenoic (DHA), docosapentaenoic acid (DPA), and eicosatetraenoic acid (arachidonic acid). EPA and DHA are omega-3 fatty acids, and are thought to offer a wide range of possible nutritional and health benefits. These benefits are reported to include reductions in cholesterol levels, anti-thrombotic effects, anti-arthritic effects in joints, and enhancement of mental and visual acuity.

Marquez et al., however, also report that, while foods and dietary supplements prepared with such polyunsaturated fatty acids may be healthier, they also have an increased vulnerability to rancidity. Rancidity in lipids, such as unsaturated fatty acids, is associated with oxidation off-flavor development. The off-flavor development involves food deterioration affecting flavor, aroma, color, texture, and the nutritional value of the particular food. Sufficient deterioration can result in safety issues with the fish oil, as well. A primary source of off-flavor development in lipids, and consequently the products that contain them, is oxidation, i.e., the chemical reaction of lipids with oxygen.

Omega-3 fatty acids, such as EPA and DHA, are readily oxidizable. The natural instability of such fatty acids, such as those derived from fish oils, gives rise to their unpleasant odor and unsavory flavor characteristics where oxidation of the fish oils has occurred, even after a relatively short period of storage time. The odor and flavor of rancid fish oils are strong and pungent. Consequently, elimination of these odors and tastes, once generated, has been difficult if not impossible. Moreover, the off-flavor odor or taste can be so malodorous that even a small level of rancidity in a fish oil-containing product can be negatively perceived by a consumer. Dietary supplements containing omega-3 oils often are packaged in dark, light-blocking containers in encapsulated form to inhibit or prevent exposure to oxygen environments, as disclosed for example in U.S. Pat. Nos. 5,077,069, 6,060,101, and 7,001,610. If dietary supplements containing omega-3 oils are contained in free liquid form rather than being encapsulated, they generally require chilled storage once opened due to exposure to the oxygen atmosphere, and typically must be consumed within at most about 15 days after opening. Despite such precautions, Marquez et al. report that such dietary supplements still tend to have a strong fish-like flavor and/or smell. Consequently, it has been very difficult in the past to produce stabilized omega-3 fatty acid-containing products or supplements having an extended shelf life. U.S. Pat. No. 6,638,557 and U.S. Application Publication No. 2003/0149118 also report the health benefits and oxidation problems generally associated fish oils.

Flaxseeds are also known to provide a rich source of fatty acids, such as alpha linolenic acid (ALA). ALA has been reported to be useful in lowering blood pressure, controlling inflammatory conditions, inhibiting autoimmune reactions, and protecting against cardiovascular disease. Another benefit of consuming flaxseeds is that they are a rich source of lignans, for example secoisolariciresinol diglycoside (SDG), which are believed to hold special pharmaceutical benefits inasmuch as they are reported to exhibit broad biological activities, including antitumor, antioxidant, antiviral and estrogenic and antiestrogenic activities.

A flaxseed product having increased stability, and a method of manufacturing the same, has been previously described in U.S. Pat. No. 6,368,650 to Pizzey, the content of which is expressly incorporated herein in its entirety for all purposes by reference thereto.

Thus, there remains a need for a food additive or dietary supplement that provides a variety of the health benefits of certain fish oil(s), yet at the same time is stable for an extended period of time to allow incorporation with other food products.

### SUMMARY OF THE INVENTION

The present invention is directed to flax-stabilized fatty acid compositions. In one embodiment, the stabilized fatty acid composition includes a selected amount of a fatty acid component, and a stable, milled flax component that is associated with the fatty acid component and that is present in an amount sufficient to increase the stability and shelf-life of the fatty acid component. The fatty acid component and flax component are substantially uniformly dispersed throughout the composition, and the stability of the flax component is not significantly increased, or not increased at all, by association with the fatty acid component. In one embodiment, the stability of the flax component is decreased by association with the fatty acid component.

The flax component can be a granulated, free-flowing powder. The fatty acid component preferably includes at least one long-chain polyunsaturated fatty acid, and more preferably the long-chain polyunsaturated fatty acid comprises an omega-3 fatty acid. Even more preferably, the omega-3 fatty acid is derived from a fish oil, and in the preferred embodiment, the omega-3 fatty acid includes eicosapentaenoic acid, docosahexaenoic acid, and docosapentaenoic acid, or a combination thereof. In one preferred embodiment, the selected amount of the fatty acid composition is sufficient to provide a nutritional benefit to a person consuming the stabilized composition. In another embodiment, the fatty acid component includes two or more long-chain polyunsaturated fatty acids, preferably two to four long-chain polyunsaturated fatty acids.

The ratio of fatty acid component to flax component can be less than about 1:25, or more preferably from about 1:100 to 1:40. In one embodiment, the fatty acid component is preferably non-encapsulated. In this embodiment, a portion of the fatty acid component typically directly contacts the flax component or even other added components in the stabilized composition. The composition can also be substantially free of ethanol or added water.

The stability of the fatty acid composition is preferably such that the fatty acid component is stable for, and has a shelf-life of, at least about 12 months under ambient temperature conditions. More preferably, the fatty acid component is stable for, and has a shelf-life of, at least about 24 months under ambient conditions, e.g., temperature.

In another preferred embodiment, the stabilized fatty acid composition includes a fatty acid component present in a selected amount, and an antioxidant component associated therewith. The antioxidant component includes one or more of lignans, phenolic acids, flavonoids, and phytic acid, or any combination thereof. The antioxidant component is present in an amount sufficient to increase the stability and shelf-life of the fatty acid component while not increasing the stability of the antioxidant component.

In another preferred embodiment, the stabilized fatty acid composition includes a fatty acid component in a selected amount, and a powdered flax component that is associated with the fatty acid component and that is present in an amount sufficient to increase the stability and shelf-life of the fatty acid component while not increasing the stability of the flax component. The stabilized fatty acid composition can be also be combined with an edible food product to produce a stable, edible food product. Alternatively, the stabilized fatty acid composition can be used in association with one or more adjuvants, including a carrier or other suitable excipient(s), to form a cosmeceutical product.

The present invention is also directed to a method for producing a stabilized fatty acid composition. In a preferred embodiment, the method includes providing a fatty acid component; and combining it with a stable, milled flax component to form a flax/fatty acid mixture, where the flax component is present in an amount sufficient to increase the stability and shelf-life of the fatty acid component while not significantly increasing the stability of the flax component. In a preferred embodiment, the stability of the flax component is not significantly affected by combination with the fish oil. Preferably, the flax component is prepared by providing a quantity of flaxseeds, and selecting a visually, uniformly colored first portion of flaxseeds by separating the first portion of flaxseeds from a second portion of the flaxseeds. The first portion preferably contain a visually, distinguishable darker color in a quantity of less than about 5%. The selected flaxseeds can then be milled into a full-fat, flax component.

Thus, the present invention provides a stabilized fatty acid composition that has an extended stability and shelf-life.

### BRIEF DESCRIPTION OF THE DRAWINGS

Further features and advantages of the invention can be ascertained from the following detailed description that is provided in connection with the drawing(s) described below:

FIGS. 1A-D are graphs showing, respectively, comparative results from Example 1 of the formation of free fatty acids, peroxides, alkenals, and malonaldehydes in samples over time;

FIGS. 2A-D are graphs showing, respectively, comparative results from Example 2 of the formation of free fatty acids, peroxides, alkenals, and malonaldehydes in samples over time; and

FIGS. 3A-D are graphs showing, respectively, comparative results from Example 3 of the formation of free fatty acids, peroxides, alkenals, and malonaldehydes in samples according to the prior art and according to the invention over time.

### DETAILED DESCRIPTION OF THE PREFERRED EMBODIMENTS

The stabilized fatty acid compositions of the present invention include a fatty acid component present in a selected amount and a flax component that is associated with the fatty acid component and that is present in an amount sufficient to increase the stability and shelf-life of the fatty acid component. Preferably, the fatty acid component and flax component are substantially uniformly dispersed throughout the composition. The stability of the flax component is typically not significantly increased by association with the fatty acid component.

The fatty acid component preferably includes a long-chain polyunsaturated fatty acid, sometimes referred to as a “PUFA”, which is defined as having at least 18 carbon atoms in its chain. All references to “fatty acids” herein refer to PUFA-type fatty acids. Exemplary types of PUFA compounds that can be used with the compositions of the present invention include omega-3, omega-6, and omega-9 fatty acids. Any suitable source of one or more PUFA compounds may be used, including marine oils, or any other oil source, for example, soybean oil, canola oil, or olive oil, whether genetically modified or not. The PUFA compound may be synthetically prepared; or extracted, isolated, or derived from a naturally occurring source. Preferably, the PUFA is obtained from a natural source. Preferably, the fatty acid component is different from the stable, milled flax component. For example, the fatty acid component is preferably derived from sources other than natural flaxseed. In preferred embodiment, the PUFA is an omega-3 fatty acid. In another preferred embodiment, the PUFA is derived from one or more marine oils, for example a fish oil, algae oil, or an extract or derivative thereof, or any combination thereof. Exemplary types of fish oils are those which include omega-3 fatty acid, such as eicosapentaenoic acid, docosahexaenoic acid, and docosapentaenoic acid, or any combination thereof. In one embodiment, the fatty acid component can include a blend of two or more PUFAs. Preferably, the fatty acid component can include two to four PUFAs. Fatty acids in general, and the specific types of fatty acids listed above, have been shown to provide beneficial health benefits upon consumption of sufficient amounts thereof.

The flax component is preferably a stable component and is prepared from full-fat or whole flaxseed, which is preferably milled or ground, preferably to obtain a powder or granulated, free-flowing particulates. Preferably, the flax component is stable for, or has a shelf-stability of, at least 6 months, more preferably at least 12 months, and even more preferably at least 24 months absent any further processing. The term “stable” or “shelf stability,” as used herein, should generally be understood to mean that, although refrigeration can be used to extend stability and shelf-life, the compositions of the invention do not require refrigeration and can be stored even at room temperature, i.e., under ambient conditions, while maintaining lipid stability and experiencing substantially no spoilage or microbiological growth over a period of time. An exemplary package for storing stable fatty acid compositions is in a standard poly-lined paper packaging at room temperature.

The stable, milled flax component may preferably be prepared according to the method disclosed in U.S. Pat. No. 6,368,650, the contents of which is incorporated herein in its entirety for all purposes by express reference thereto. In general, the method of preparing stable flax component of the '650 patent is based on the fact that stability and shelf-life of the flax component can be improved by using a supply of flaxseeds having a content of visually, distinguishable darker color seeds. Preferably, the content of the visually, distinguishable darker seeds in the select seeds is less than about 5%, more preferably less than about 3%, and even more preferably less than about 1%. Prior to milling, the seeds are preferably subjected to a separation step to remove any foreign or undesired materials. Such separation steps can include, for example, aspiration, sifting, or other similar techniques to produce the final powder or particulate form of the flax component used in stabilizing fatty acids to provide the compositions of the invention.

While not being bound by theory, it is thought that the achieved stability of the flax component is due at least in part to the fact that flaxseeds have a relatively active and stable antioxidant system, and include, for example, various mixtures of one or more lignans, phenolic acids, flavonoids, and phytic acid, which are agents known to have antioxidant activity. The present invention, therefore, encompasses in one embodiment any natural or synthetic antioxidant agent or composition that provides the same or similar antioxidant effect. Preferably, the antioxidant agent includes one or more of a lignan, phenolic acid, flavonoid, phytic acid, or a combination thereof. More preferably, the antioxidant agent includes one or more phenolic acids and at least one lignan or flavonoid. In a most preferred embodiment, the antioxidant agent includes at least one lignan, one phenolic acid, one flavonoid, and phytic acid. The antioxidant agent, when included in lieu of or in addition to the stable, milled flax component, is present in an amount sufficient to provide an antioxidant or stabilizing effect to the fatty acid component. Preferably, this stabilizing effect is at least substantially similar, or effectively the same, as a natural stable, milled flax component.

In other embodiments, the flax component can be prepared using any other methods available to those of ordinary skill in the art to produce a stable flax component. For example, one embodiment may include recovering a significantly increased amount of flaxseed hull portions from a plurality of harvested flaxseeds to produce a flaxseed hull extract, as described in U.S. Pat. No. 7,048,960 to Pizzey, the contents of which is also incorporated herein in its entirety for all purposes by express reference thereto. Including such a flaxseed hull extract in the stable, flax component can advantageously increase the lignan concentration of the stabilized fatty acid compositions of the invention, and thus the overall nutritional and health benefits thereof. In another embodiment, the flax component can be prepared from the entire seed or from only portions thereof; can be processed using steps other milling or grinding; and can include the addition of other additives or components. In one such embodiment, the portion of the flax seed selected as the stable, milled flax component includes one or more lignans, phenolic acids, flavonoids, and phytic acid present in the unmilled flax component. Additional amounts of any of these materials can be added, as well, either through concentration of natural flax extracts or other natural seeds or products, or through addition of one or more of these materials from a synthetic source. Preferably, the flax is milled to form a powder or free-flowing granulate.

The fatty acid component is preferably added to or associated with, and more preferably mixed or blended with, the milled, flax component to form the stable fatty acid composition. Preferably, the fatty acid and flax components are thoroughly combined so that each component is at least substantially uniformly dispersed, preferably uniformly dispersed, throughout the composition. Preferably, neither the flax component or fatty acid component are encapsulated so that each can thoroughly contact the other to minimize or avoid degradation. Preferably, the fatty acid component and flax component are combined without any added water. More preferably, the entire process for preparing the stable fatty acid composition is substantially free, and even more preferably completely free, of added water or alcohol, such as ethanol, and preferably both. Additionally, the mixed flax/fatty acid blend is preferably not subjected to heating, such as by extrusion, or other pressing steps to remove oils from the mixture, as this may detrimentally affect the fatty acid quality.

Due to its association with the stable flax component, the fatty acid component exhibits an increased stability and shelf-life within the composition. While not being bound by theory, it is thought that the increased stability is achieved in part due to the antioxidant activity of the stable flax component, which may provides oxidation protection to the fatty acid component upon interaction therewith. The stable fatty acid compositions are preferably stable for at least 12 months, and more preferably are stable for at least 24 months, under ambient conditions. In the preferred embodiment, the association of the fatty acid component with the flax component also does not significantly increase, and in some cases does not increase at all, the stability of the flax component in the final composition. In another embodiment, the stability of the flax component decreases in the final composition while increasing the stability of the fatty acid component.

The stability of the fatty acid and flax components, as well as the compositions of the invention, are preferably characterized by the level of one or more decomposition/oxidation byproducts that form in the composition over time. Such byproducts can include, for example, amounts of one or more free fatty acids, peroxides, alkenals, and malonaldehydes, or any combination thereof. Preferably, the levels of these byproducts in the stable compositions are relatively low and less than a pre-determined threshold, e.g., a threshold that is detectable by a patient or consumer of a product containing the stable fatty acid compositions of the invention. For example, the level of free fatty acids is preferably less than about 2 weight percent, more preferably less than about 1.5 weight percent, and even more preferably less than about 1 weight percent based on the total fatty acid of the stable composition, e.g., oleic oil. The peroxide level in the composition over time is preferably less than about 5 meq/kg, more preferably less than about 2 meq/kg, and even more preferably less than about 1 meq/kg of oil. For alkenals, the level is preferably less than about 300 nmol/ml, more preferably less than about 200 nmol/ml, and even more preferably less than about 100 nmol/ml. Finally, the composition level for malonaldehydes are preferably less than about 30 nmol/ml, more preferably less than about 20 nmol/ml, and even more preferably less than about 10 nmol/ml. In other embodiments, stability can be characterized based on other thresholds, or based on the presence and formation of other byproducts in the compositions.

Additionally, the increased stability of the fatty acid component can advantageously be achieved without encapsulating or otherwise shielding the fatty acid component from the flax component and/or ambient environment. For example, neither the fatty acid component nor the final fatty acid composition requires encapsulation by barrier materials or coatings (e.g. starch-based compounds), as was previously required for other compositions in order to suitably prevent oxidation and decomposition of the fatty acid components. Preferably, the fatty acid component and the stable flax component are in direct contact with each other, such as by being substantially uniformly dispersed in the stable composition of the invention. The stable fatty acid composition can also be stored at ambient conditions without experiencing decomposition, which is in contrast to previous fatty acid compositions that typically required storing at refrigerated temperatures upon exposure to oxygen environments to limit or substantially reduce decomposition.

Preferably, the amount of fatty acid component present in the composition is less than, and is more preferably substantially less than, the amount of flax component present therein, but is preferably also present in an amount sufficient to provide a nutritional/health benefit. This is believed, without being bound by theory, to be due to the stabilizing activity of the flax component. The ratio of fatty acid component to flax component on a weight/weight basis is preferably less than about 1:1 to 1:150, is preferably less than about 1:10 to 1:125, is more preferably less than about 1:25, and is even more preferably less than about 1:40. In one embodiment, the ratio is from about 1:50 to about 1:100. In other embodiments, the weight percent of the fatty acid component in the final fatty acid composition is less than about 20%, preferably less than about 10%, more preferably less than about 5%, and even more preferably less than about 2%. Further illustrative examples of the relative amounts of components in the stabilized fatty acid compositions are described in the Examples provided below.

The mixture of fatty acid and flax components are preferably formed into desired shapes or forms, e.g., consistent lengths of pellets or products/compositions, or ground up to be used in tablets or other formulations. The formed compositions are preferably in a ready-to-use or ready-to-eat form such that they can easily be incorporated into a variety of useful end products for consumer use. A few examples include food products, pharmaceuticals, cosmetics or cosmeceuticals, nutritional supplements, food additives, or animal feeds. Particularly preferred food products include yogurt and dough-based products including muffins, breads, pizza mixes, cereals, or any combination thereof. The formed compositions preferably include properties that enable it to be readily handled, stored, and processed like any other dry ingredient that is typically using for baking, e.g. flour.

Advantageously, the stable fatty acid composition of the present invention provides a more desirable taste and shelf stability when combined with the food products or other edible consumer products. For example, when the fatty acid component is a fish oil and the stable composition is combined with a food product, taste surveys indicate that the food product including a taste-detectable amount of the composition of the present invention has a more desirable taste, even when compared to a food product that does not include any fish oil at all. Moreover, as exemplified below, the food products are stabilized with natural ingredients and can be safely stored under refrigerated or frozen conditions, as well as simply on a shelf, for significant lengths of time and still remain fresh and tasteful. Preferably, the compositions of the invention are substantially or entirely free of conventional preservative components such as parabens or benzoates having the sole function of being a preservative. In connection with stable food products incorporating stable fatty acid compositions of the invention, the compositions are typically present in an amount of about 0.1 to 30 weight percent, preferably about 1 to 25 weight percent, and more preferably about 5 to 15 weight percent, of the weight of the food product. For example, 2000 g of muffin mix might include 200 g of the stable fatty acid composition of the invention.

Particularly in the case of pharmaceuticals, cosmetics, or cosmeceuticals, the stable fatty acid composition can be included in any suitable dosage or application form, including lotions, creams, shampoos, lipsticks, powders, masks, bandages, or the like. Although any suitable route of administration of formulations incorporating the fatty acid composition is suitable, preferably they are orally administered in the case of pharmaceutical formulations. In the case of animal feeds, the feed containing the stable fatty acid composition according to the invention can promote healthy skin or fur coats in pets, such as dogs or other animals with fur. Preferably the patient is a mammal, and more preferably human. In the case of cosmetics or cosmeceuticals, the stable fatty acid composition is preferably administered topically or transdermally.

### EXAMPLES

The present invention is illustrated by the following Examples that are merely for the purpose of illustration and are not to be regarded as limiting the scope of the invention or the manner in which it can be practiced. In each Example, levels of decomposition and/or oxidation byproducts formed over time in all samples were tested using the SAFTEST MAPP™ System by Safety Associates, Inc. of Irvine, Calif., which is a micro-analytical testing system that measures primary and secondary oxidation in food products. The cut-off threshold values for four decomposition/oxidation assays in the SAFTEST MAPP™ System were as follows: <2.0% oleic oil for the free fatty acid assay, <5.0 meq/kg of oil for the peroxide assay, <300 nmol/ml for the alkenal assay, and <30 nmol/ml for the malonaldehyde assay.

### Example 1

### Comparative Flax/Tuna Oil Blend Real Time Study

The objective was to compare the lipid stability of a stabilized fatty acid composition to a control. In this case, the fatty acid component was tuna oil (unencapsulated), which was mixed with a milled, flax component to form a milled, flax/tuna oil blend or composition (MFTO) of the invention. The MFTO was compared to a stable milled flax control (MF), which did not include a fatty acid component, under real time, ambient temperature conditions.

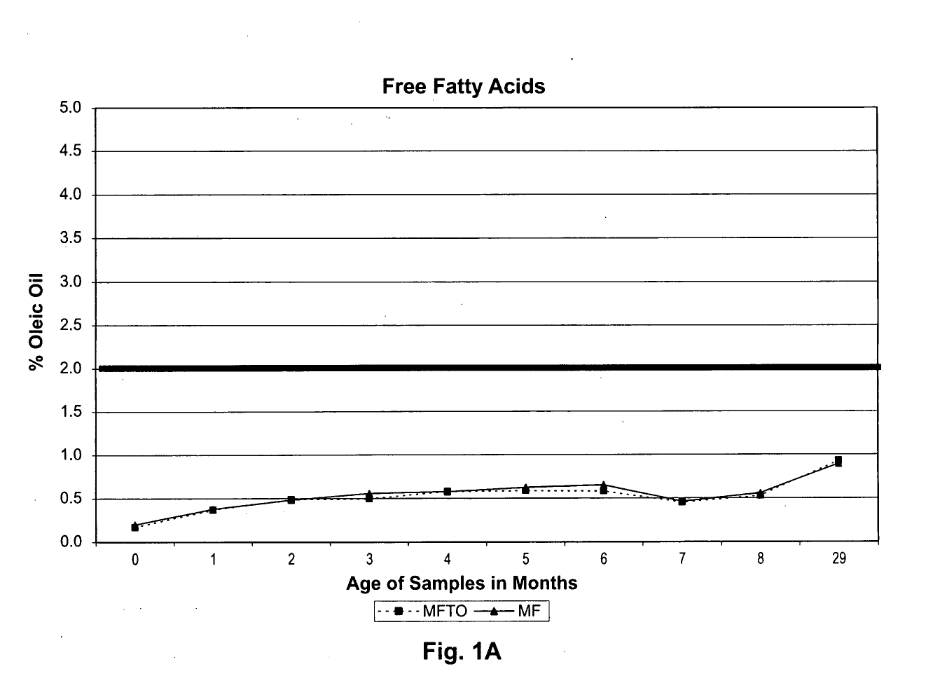

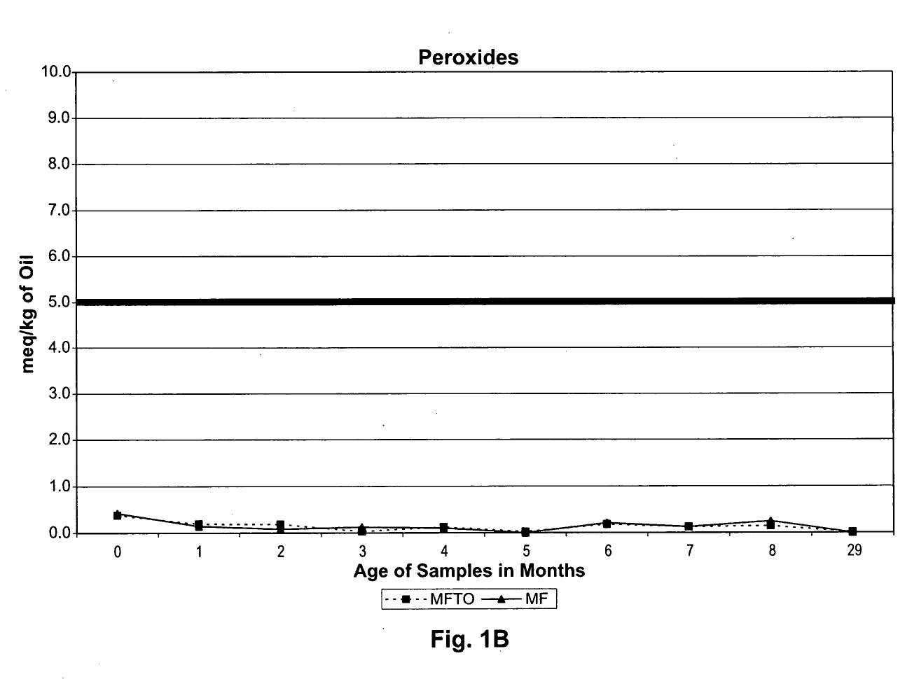

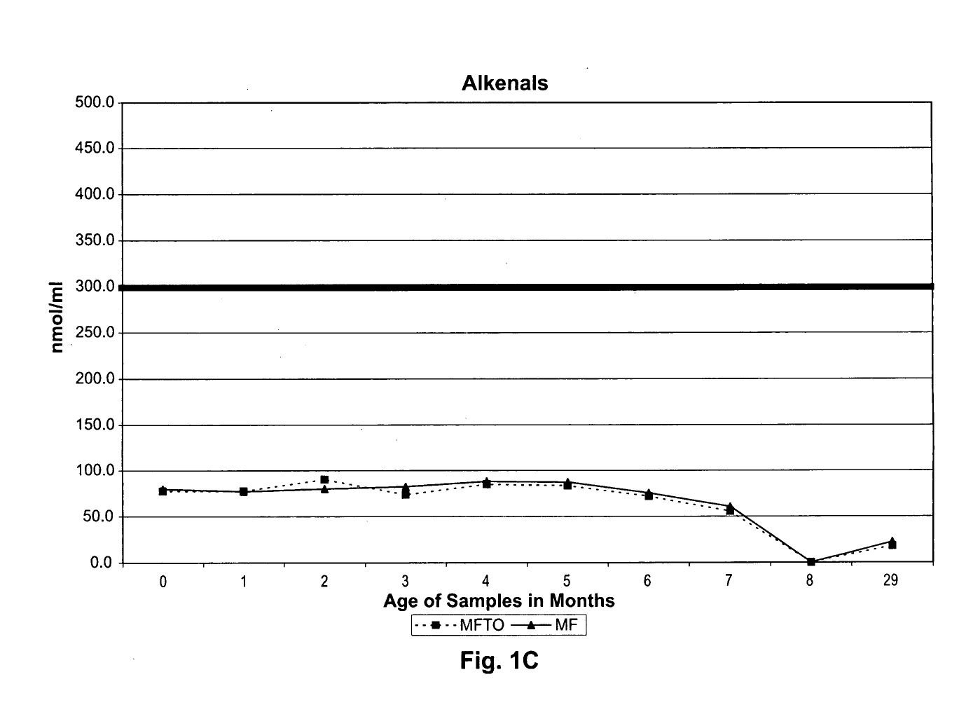

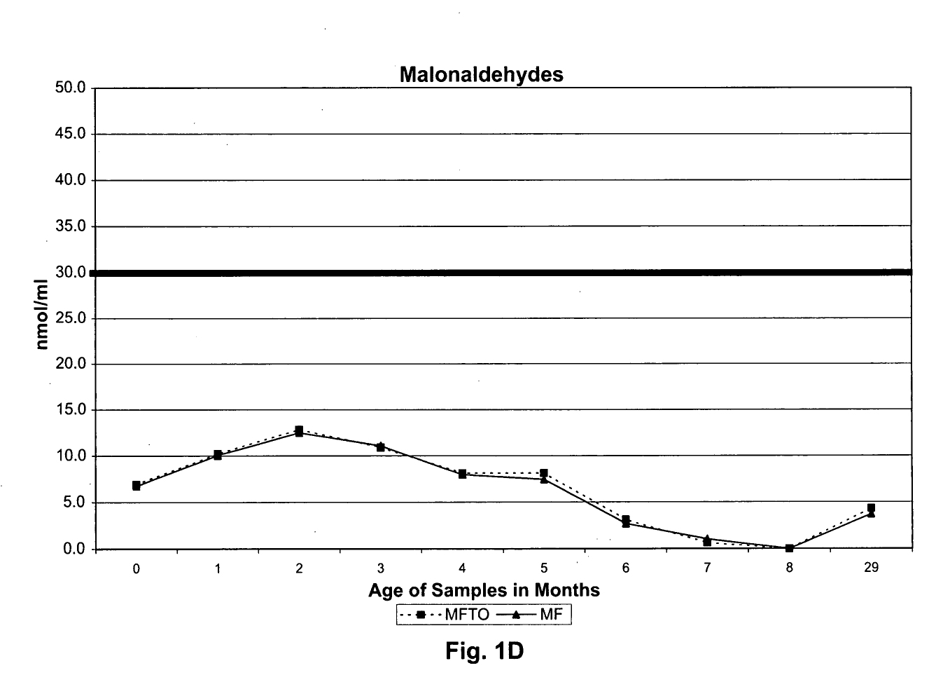

Two samples were prepared: the first was the MFTO with tuna oil added at an inclusion rate of 2%, and the second was the control MF containing just milled flaxseed. Both samples were tested every month for 8 months, and then again at 29 months, and the comparative results for each assay are shown in FIGS. 1A-D. FIG. 1A shows free fatty acid(s); FIG. 1B shows peroxide(s); FIG. 1C shows alkenal(s); and FIG. 1D shows malonaldehyde(s).

As is seen in FIGS. 1A-D, there was no significant difference in the formation of decomposition/oxidation byproducts between the MFTO and MF samples. Both samples were well below the pre-determined threshold limits for each of the four assays, even when tested after 29 months. The stability of the MFTO composition was similar to that of the MF control, despite the inclusion of tuna oil in the MFTO composition. The results clearly indicate that the lipid stability of the stabilized fatty acid composition of the invention, in this case a milled flax/tuna oil blend, was acceptable when stored under ambient conditions.

### Example 2

### Lipid Stability of a Flax/Fish Oil Blend Under Ambient Storage Conditions

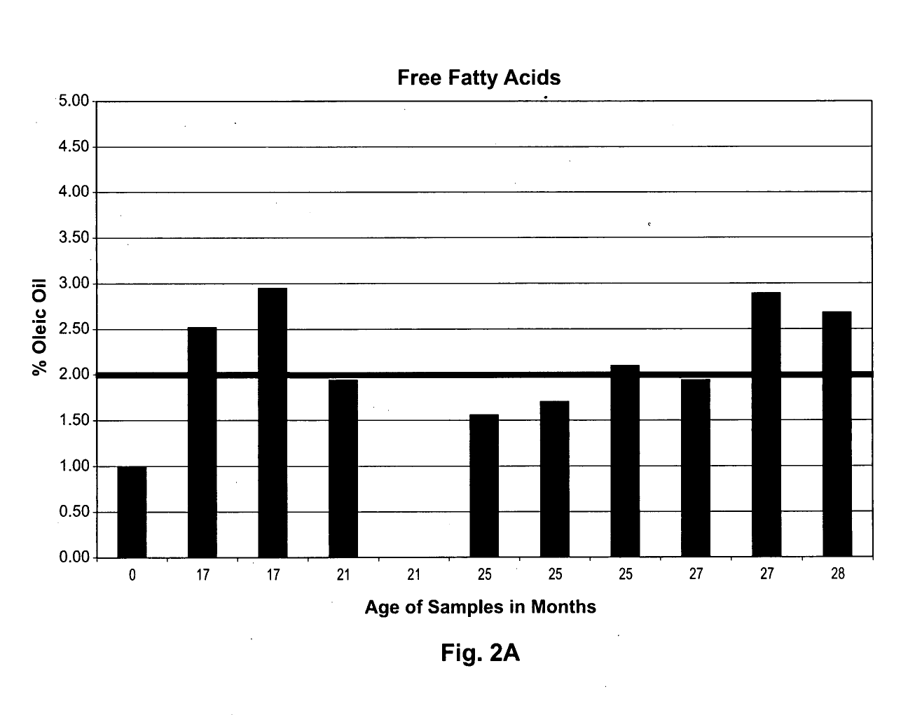

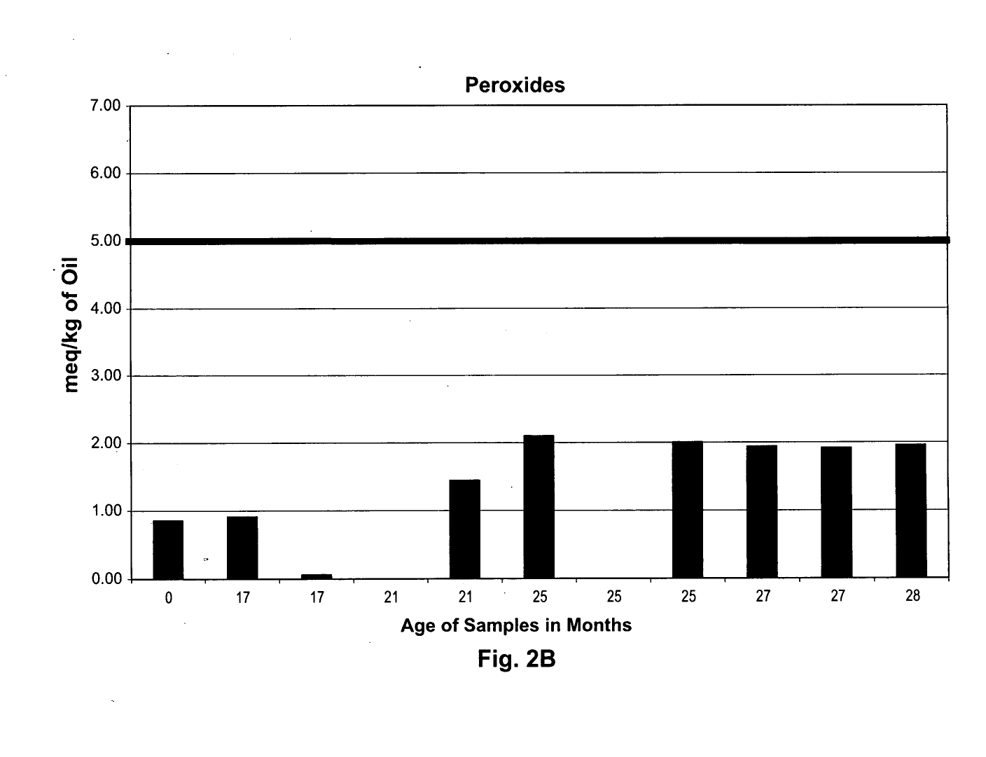

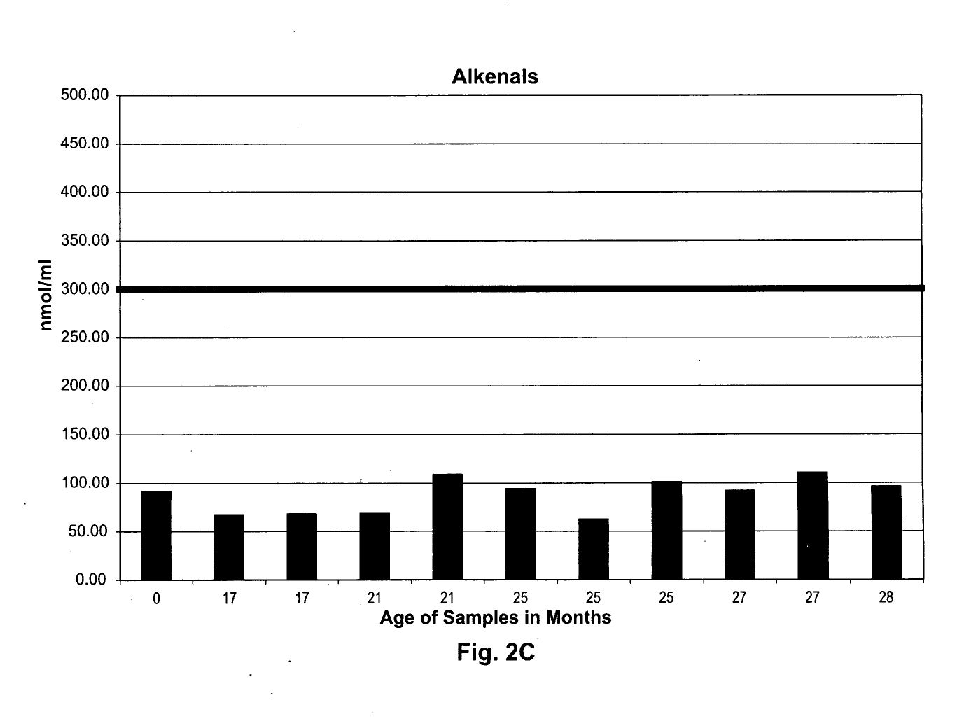

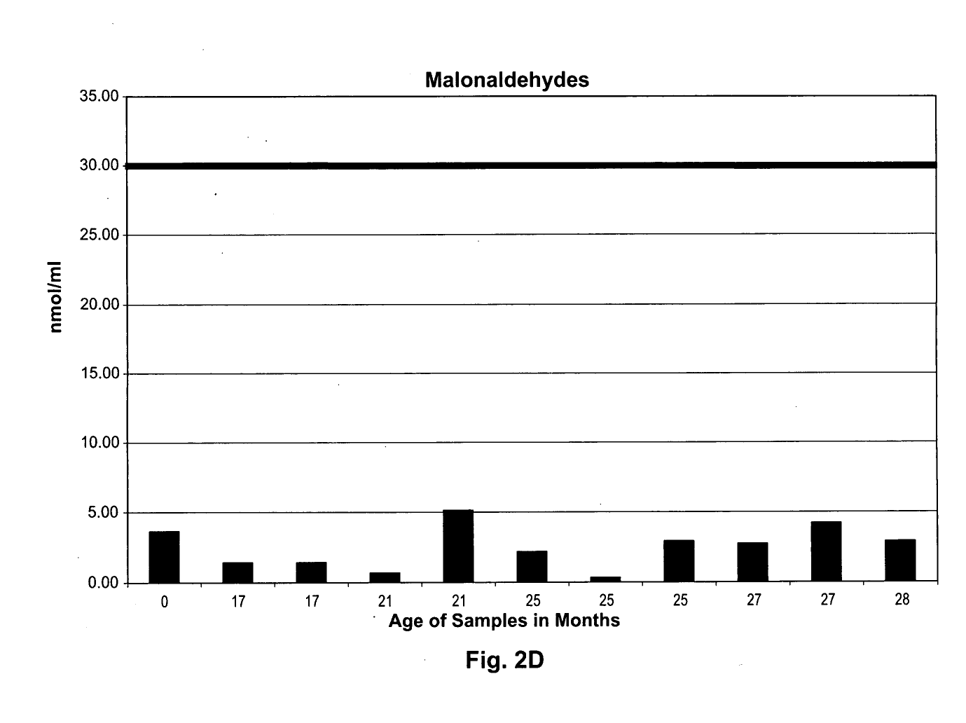

Ten samples of a flax/fish oil blend according to the invention were evaluated for stability and byproduct formation over a lengthy time period. The samples were prepared, stored under ambient conditions, and then tested 17 to 28 months after preparation. The ten samples were prepared from different lots of flaxseed, which were milled and then blended with fish oil (unencapsulated) at an inclusion rate of 2.4%. The testing results for the ten samples for each assay are shown in FIGS. 2A-D, with FIG. 2A showing free fatty acid(s); FIG. 2B showing peroxide(s); FIG. 2C showing alkenal(s); and FIG. 2D showing malonaldehyde(s) at various times, including t=0 to provide a baseline.

The results indicate that all of the samples maintained acceptable lipid stability through at least 28 months. A few samples (e.g., samples tested at 17, 25, 27, and 28 months) exhibited slightly elevated levels of one or more free fatty acids, however, they did not appear to have a significant impact on the quality of the composition. Furthermore, testing results for the other three assays (peroxides, alkenals, and malonaldehydes) for these samples were all significantly below the pre-determined threshold limits. The results clearly indicate that the lipid stability of each of the ten fatty acid compositions of the invention, in this case a milled flax/fish oil blend, was acceptable when stored under ambient conditions.

A comparative taste study was also conducted before a tasting panel. Two types of muffins were prepared: the first included a conventional muffin mix containing a sample of one of the flax/fish oil blends stored for 28 months, and the second was a control muffin mix that did not include any fish oil. The two types of muffins were both tasted by each of 17 taste testers. Surprisingly, 15 of the 17 taste testers indicated that they preferred the muffin with the flax/fish oil blend over the control muffin. The results indicate that despite being stored in ambient conditions over lengthy time periods, the stabilized fatty acid compositions of the invention did not produce a rancid taste or smell poorly, as unencapsulated fish oil is expected to do after only hours to days. Moreover, the added flax/fish oil blend unexpectedly produced a more desirable and palatable taste to the vast majority of taste testers.

### Example 3

### Comparative Accelerated Shelf-Life Tests for Fish Oil and Encapsulated Fish Oils

The objective was to compare the antioxidant effect of milled flaxseed on the lipid stability of both a refined and an encapsulated fatty acid component, in this case the fatty acid being fish oil.

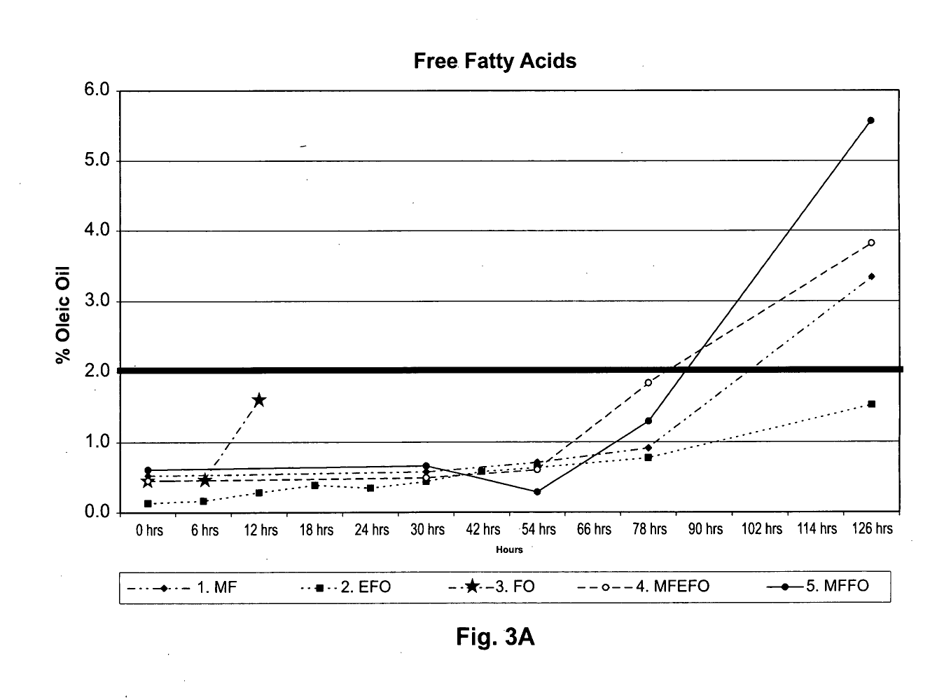

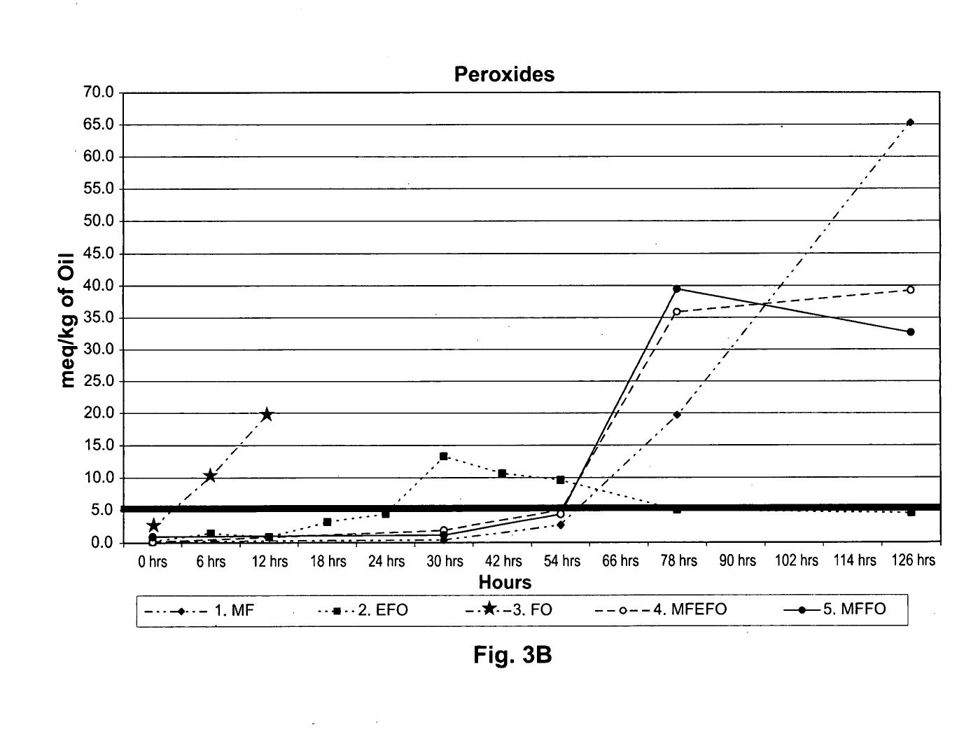

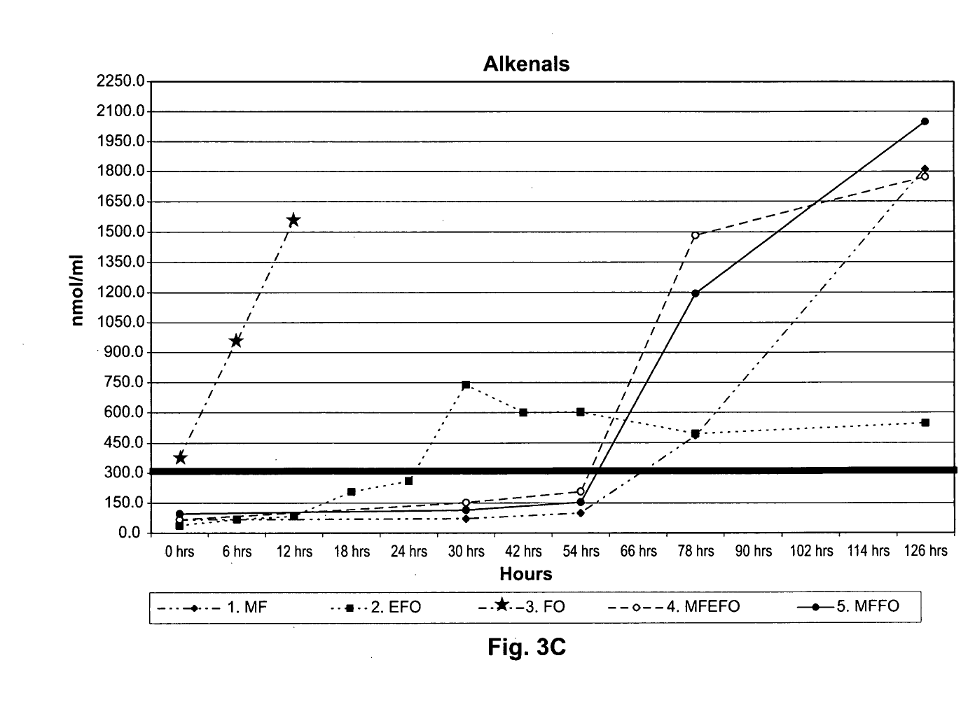

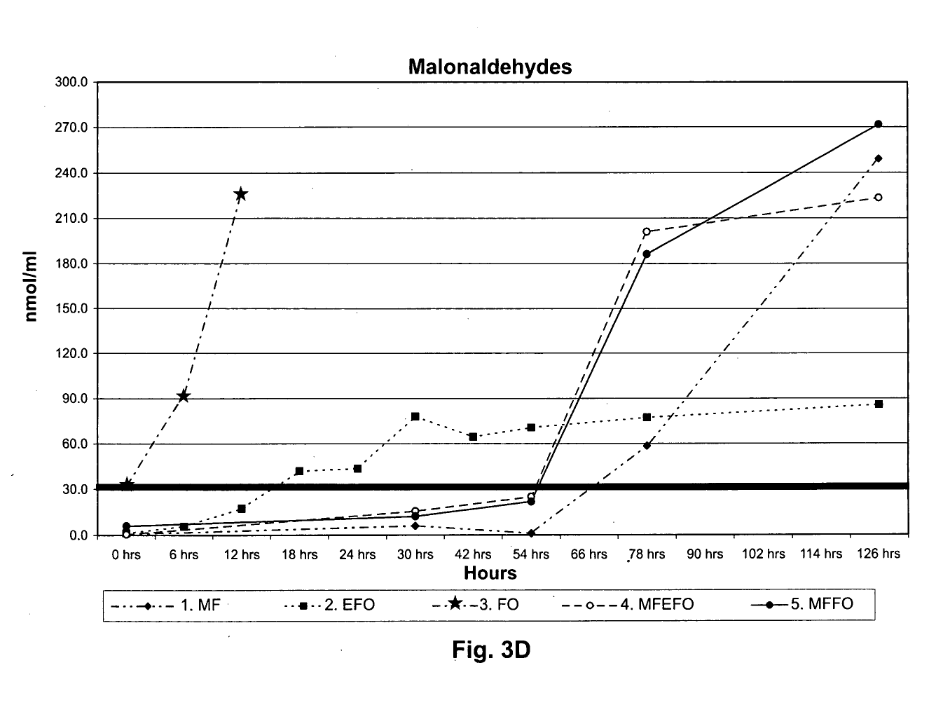

The samples were tested under accelerated shelf-life conditions. Each of five samples were placed in an oven at 80° C., and the samples were tested at 6 and 12 hour intervals for 126 hours. The five samples included: 1) a milled flaxseed control (MF), 2) a prior art encapsulated fish oil powder (EFO), 3) a sample of non-encapsulated fish oil control (FO), 4) a milled flax and encapsulated fish oil blend (MFEFO), and 5) a milled flax and non-encapsulated fish oil blend of the invention (MFFO). The MFEFO and MFFO blends were formulated with 18% EPA and 12% DHA derived from fish oil. The accelerated shelf-life testing results for the five samples for each assay are shown in FIGS. 3A-D, with FIG. 3A showing free fatty acid(s); FIG. 3B showing peroxide(s); FIG. 3C showing alkenal(s); and FIG. 3D showing malonaldehyde(s) at various times, including t=0 to provide a baseline.

As expected, the results indicate that the MF control was the most stable of the tested samples as it did not contain fish oil. The MFEFO and MFFO samples both showed less stability compared to the MF control, but the milled flax component surprisingly extended the beginning of induction for both these samples to at least about 50 hours. Furthermore, there was no significant difference between the lipid stability of the encapsulated and non-encapsulated fish oil when incorporated into the milled flax matrix.

The results for the FO and EFO samples, however, indicated that these samples were significantly less stable. For example, the results of the peroxide, alkenal, and malonaldehyde assays for the FO sample exceeded the pre-determined threshold limits after only about 6 hours, which indicates that the FO sample produced significant amounts of primary and secondary decomposition/oxidation byproducts in a relatively short time. Testing for the FO sample was discontinued after 12 hours due to the high levels of byproducts produced. The EFO sample showed only slightly better stability results. For example, the results of the peroxide, alkenal, and malonaldehyde assays for the EFO sample exceeded the pre-determined threshold limits after only about 15 to 25 hours. Again, the stability of the EFO sample was significantly decreased when compared to the MFEFO and MFFO samples, which were mixed with the milled flax component.

The term “about,” as used herein, should generally be understood to refer to both numbers in a range of numerals. Moreover, all numerical ranges herein should be understood to include each whole integer within the range. Unless otherwise specified, all percentages herein refer to weight percent instead of volume percent.

The term “substantially free,” as used herein, refers to no more than about 5 weight percent, preferably no more than about 2 weight percent, and more preferably no more than about 1 weight percent of the undesirable component, e.g., alcohol or alcoholic compound(s), based on the total weight of flaxseeds. In one more preferred embodiment, the term means no more than about 0.5 weight percent, preferably no more than about 0.1 weight percent, and more preferably no more than about 0.01 weight percent, of the undesired component. The term “completely free” means no more than a trace amount of such undesired material(s) are present, e.g., as an impurity.

While illustrative embodiments of the invention are disclosed herein, it will be appreciated that numerous modifications and other embodiments may be devised by those of ordinary skill in the art and the invention is not to be understood to be limited to such illustrated embodiments. Therefore, it will be understood that the appended claims are intended to cover all such expedient modifications and embodiments that come within the spirit and scope of the present invention, including those readily attainable by those of ordinary skill in the art from the disclosure set forth herein, or by routine experimentation therefrom.

What is claimed is:

1. A stabilized fatty acid composition comprising:
a fatty acid component present in a selected amount; and
a stable, milled flax component that is associated with the fatty acid component and that is present in an amount sufficient to increase the stability and shelf-life of the fatty acid component;
wherein the fatty acid component and flax component are substantially uniformly dispersed throughout the composition, and the stability of the flax component is not significantly increased by association with the fatty acid component.

2. The stabilized fatty acid composition of claim 1, wherein the stability of the flax component is decreased by association with the fatty acid component.

3. The stabilized fatty acid composition of claim 1, wherein the flax component is a granulated, free-flowing powder.

4. The stabilized fatty acid composition of claim 1, wherein the fatty acid component comprises at least one long-chain polyunsaturated fatty acid and the selected amount is sufficient to provide a nutritional benefit.

5. The stabilized fatty acid composition of claim 4, wherein the long-chain polyunsaturated fatty acid comprises an omega-3 fatty acid.

6. The stabilized fatty acid composition of claim 5, wherein the omega-3 fatty acid is derived from a fish oil.

7. The stabilized fatty acid composition of claim 5, wherein the omega-3 fatty acid comprises eicosapentaenoic acid, docosahexaenoic acid, and docosapentaenoic acid, or a combination thereof.

8. The stabilized fatty acid composition of claim 4, wherein the fatty acid component comprises two or more long-chain polyunsaturated fatty acids.

9. The stabilized fatty acid composition of claim 1, wherein the ratio of fatty acid component to flax component is less than about 1:25.

10. The stabilized fatty acid composition of claim 9, wherein the ratio of fatty acid component to flax component is from about 1:100 to 1:40.

11. The stabilized fatty acid composition of claim 1, wherein the fatty acid component is non-encapsulated.

12. A shelf stable, edible food product comprising an edible food component and the stabilized fatty acid composition of claim 1.

13. The stabilized fatty acid composition of claim 1, wherein the composition is substantially free of ethanol or added water.

14. The stabilized fatty acid composition of claim 1, wherein the fatty acid component is stable for, and has a shelf-life of, at least about 12 months under ambient temperature conditions.

15. The stabilized fatty acid composition of claim 14, wherein the fatty acid component is stable for, and has a shelf-life of, at least about 24 months under ambient conditions.

16. A stabilized fatty acid composition comprising:
a fatty acid component present in a selected amount; and
an antioxidant component, comprising one or more of lignans, phenolic acids, flavonoids, and phytic acid, or any combination thereof that is associated with the fatty acid component and that is present in an amount sufficient to increase the stability and shelf-life of the fatty acid component while not increasing the stability of the antioxidant component.

17. A stabilized fatty acid composition comprising:
a fatty acid component present in a selected amount; and
a powdered flax component that is associated with the fatty acid component and that is present in an amount sufficient to increase the stability and shelf-life of the fatty acid component while not increasing the stability of the flax component.

18. The stabilized fatty acid composition of claim 17, wherein the ratio of fatty acid component to flax component is less than about 1:25.

19. The stabilized fatty acid composition of claim 17, wherein the fatty acid component is stable for, and has a shelf-life of, at least about 12 months under ambient conditions.

20. A method of producing a stabilized fatty acid composition which comprises:
providing a fatty acid component; and
combining a stable, milled flax component to the fatty acid component,
wherein the flax component is present in an amount sufficient to increase the stability and shelf-life of the fatty acid component while not significantly increasing the stability of the flax component.

21. The method of claim 20, wherein the stable, milled flax component is prepared by:
providing a quantity of flaxseeds;
selecting a visually, uniformly colored first portion of flaxseeds by separating the first portion of flaxseeds from a second portion of the flaxseeds, said first portion containing a visually, distinguishable darker color in a quantity of less than about 5%; and
milling the selected flaxseeds into a full-fat, flax component.

22. The method of claim 20, wherein the stabilized fatty acid component is stable for, and has a shelf-life of, at least about 12 months under ambient conditions.

23. The method of claim 20, which further comprises associating an edible food component and the stabilized fatty acid composition to form a shelf stable food product.
